(19) United States
(12) Patent Application Publication
(10) Pub. No.: US 2022/0063749 A1
(43) Pub. Date: Mar. 3, 2022

(54) ChainBath-chain cleaning device and method

(71) Applicant: Horatiu Daniel Chiriac, Montreal (CA)

(72) Inventor: Horatiu Daniel Chiriac, Montreal (CA)

(21) Appl. No.: 17/006,369

(22) Filed: Aug. 28, 2020

(51) Int. Cl. B62J 50/16; B08B 1/00; B08B 1/02; B08B 15/04; B08B 3/04; B08B 3/10

(52) U.S. Cl. CPC B62J 50/16; B08B 1/002; B08B 3/102; B08B 15/04; B08B 3/041; B08B 1/02

(57) ABSTRACT

A device and a method of using the same, the chain cleaning device forming a bath-like cavity in the lowest point of the chain travel, around the rear sprocket of a motorcycle or another rotating part of a chain-driven mechanism. This device allows for the chain to be completely or partially submerged in chain cleaning liquid, allowing for best coverage of chain cleaning liquid on the chain, a more efficient and thorough cleaning and minimizing the waste of the liquid and the pollution.

### TECHNICAL FIELD

The present invention relates to a vehicle chain transmission chain cleaning device and method.

### BACKGROUND

Most small vehicles with 2, 3 and 4 wheels (motorcycles, bicycles, trikes and all-terrain vehicles) are equipped with a chain transmission. While it is inexpensive and efficient, the chain requires constant maintenance for a long life, reduced friction and gas consumption. The best method to clean the chain is to remove it from the vehicle and submerge it into a bath of chain cleaning liquid, but it is very difficult to do this every time.

Most of the times, cleaning involves the spraying of a chain cleaner on the chain and most of it is wasted into the environment and is not really cleaning.

A new device and method to make the chain maintenance easier and more effective is presented.

### SUMMARY

a) A first aspect of the present invention is directed to the device for the cleaning.

Using the lowest point in the chain travel around the sprockets, or creating a low point, ChainBath device will create a cavity that can hold the cleaning liquid. It will allow for a section of the chain to be submerged completely or partially in chain cleaning liquid, without removing the chain from the chain driven mechanism.

The ChainBath may be designed to contain the chain and the sprocket's lowest part. The chain cleaning quantity is minimized to avoid the unnecessary spilling and waste and to maximize the coverage and the cleaning of the chain.

A tray-like part of the device may connect the ChainBath below the chain to the forward part of the chain, to collect the cleaning liquid that drips from the chain, directing it to the ChainBath. This tray can be interlocked with the ChainBath to avoid spilling. It could also be used as a cover for the ChainBath to seal the inside when transporting it and avoid leaks.

The tray can be optional. For easy storage, the tray can be designed into multiple interlocking parts, telescopic, sliding or folding.

An optional brush can be also installed on the device that could help with the cleaning by removing the dirt. The brush could be installed in different positions on the device or in other position and it could be fixed or rotating with the chain or the sprocket and clean the chain when it passes through.

ChainBath can be a generic type device that can work on most chain driven mechanism.

ChainBath could also be made specifically for a certain model of vehicle, to conform to the specific geometry of the sprocket, chain, swing arm, chain guard and the design of the vehicle and accessories.

ChainBath could be permanently mounted on the vehicle, mounted for a short time to allow the cleaning, or it could be ground or stand supported, independent of the vehicle.
b) A second aspect of the present invention is directed to multiple methods for, using a device to clean the chain of a motorcycle or other chain-driven vehicles.
   1) A first method would have a vehicle be supported on a center stand or a pit stand, with the rear wheel in the air. The ChainBath device is installed to contain the chain and the lower part of the rear sprocket, and with the chain cleaning liquid inside, submerging the chain inside the device partially or completely. The tray and the brush could be optionally installed.

With the chain submerged, the chain is moved through the cleaning solution, either rotation the rear wheel or other method, bringing a different part of the chain into the ChainBath to be submerged. The whole chain is now covered and in most embodiments it will be completely submerged and soaked in chain cleaning liquid. The fact that the chain passes completely through the cleaning liquid, agitating it and it rotates around the sprocket while submerged in liquid makes a good cleaning exactly where it is needed, between the chain links, rollers and also the rubber seals, removing debris, keeping it wet and reducing friction. The device collects most of the cleaning liquid and the dirt that drips from the chain, reducing the waste. The optional tray can reduce almost completely the waste and spilling of the cleaning liquid. The device collects the liquid and dirt that drips from the chain.

After cleaning the chain, if the ChainBath is temporarily installed on the motorcycle, it can be lowered and allow for a complete draining of the liquid. If the ChainBath is permanently installed on the motorcycle, an optional draining tub may allow draining the cleaning liquid and the dirt accumulated.
2) A second method would allow cleaning the chain without a stand. The ChainBath will be installed temporarily or permanently on the chain driven vehicle. The chain cleaning liquid will be poured inside the device to completely or partially cover the chain inside. Then the vehicle would be moved forward or backward to allow the chain to pass through the device, be submerged in cleaning liquid and remove the dirt.

The optional tray and brush could be also installed.

Once the chain is cleaned, if the ChainBath is temporarily installed, it can be lowered to allow for the liquid to drain from the chain and sprocket. If the ChainBath is permanently installed, the optional drain tube can be used to drain the liquid and the dirt removed from the chain.

### BRIEF DESCRIPTION OF THE DRAWINGS

In the present embodiment the device is installed on a chain driven motorcycle. Other vehicles could use the same idea.

Further aspects and advantages of the present invention will become better understood with reference to the description in association with the accompanying drawings in which:

FIG. 1 is a side view of the motorcycle, with the device and the tray installed

FIG. 2 is Section A-A from the FIG. 1 that shows the tray and the chain inside

FIG. 3 is Section B-B from FIG. 1 that shows the device, the chain, the rear sprocket and the level of the cleaning liquid.

FIG. 4 is a side view of the motorcycle, with a another version of the device

FIG. 5 is an isometric view of the design that has a cover that closes the device

FIG. 6 is an isometric view of the same design, with the cover installed as a tray to collect the dripping solution from the chain

FIG. 7 is an isometric view of the same design from a different angle that shows how the cover is used as a tray.

FIG. 8 is a front view of the same design where the cover has a feature that allows it to be installed as a tray

FIG. 9 is a front view of a another design that has brushes

FIG. 10 is a detailed view of the FIG. 9 presenting details of the brushes

### DETAILED DESCRIPTION

The present invention relates to a device that can allow for an easier chain cleaning of a chain driven vehicle. The following description illustrates one exemplary embodiment of the invention on a chain driven motorcycle. The skilled person will readily understand that different components and designs could be used to achieve the same result.

In the illustrated. embodiment, a device is made to contain the lowest part of the travel of the chain and the rear sprocket. It will create a bath-like cavity that can contain a part of the chain and a chain cleaning liquid that would completely or partially cover the chain inside. This device can be permanently or temporarily installed on the motorcycle. This device can be generic or specific for the chain driven vehicle (bicycle, motorcycle, trike, all-terrain vehicle, etc).

Different methods could be used to position the device in the right position to allow the chain to be submerged while installed on the vehicle.

Optionally, a tray could be installed below the chain between the device and the front sprocket, to collect the liquid and dirt and drain it into the device.

A cover could seal the inside of the device for storage or transport. In certain designs, the cover could be used as a tray also.

The following are the components of an exemplary chain cleaning device and the motorcycle.

1. Rear wheel

2. Swing arm

3. Front sprocket

4. Rear sprocket

5. Chain

6. Cleaning device

7. Tray

8. Liquid level

9. Draining tube

10. Brush

11. Mounting feature

12. Cover

13. Cover mounting feature

14. Fixed brush

15. Rotating brush

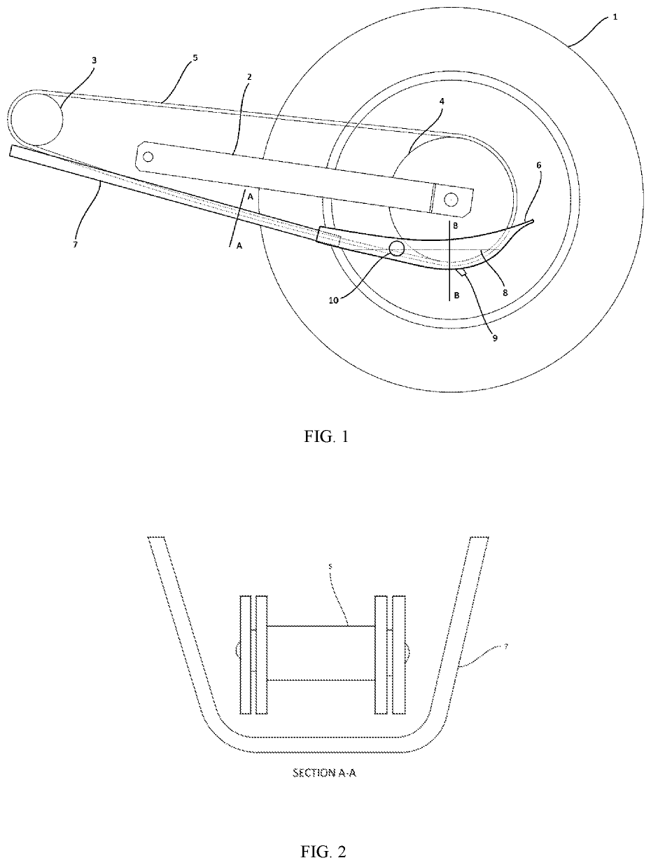

In FIG. 1 there is illustrated a chain cleaner device 6 which is shown in position on a motorcycle chain 5 and the rear sprocket 4.The rear sprocket 4 is installed on a swing arm 2 and the rear wheel 1.

The chain 5 passes between front sprocket 3 and the rear sprocket 4, transmitting the engine power from the engine to the rear wheel 1 in a normal configuration for a chain driven vehicle.

The housing of the chain cleaning device 6 is located at the lowest position on the chain 5 travel.

The housing creates a bath-like enclosure where the cleaning solution 8 can be added.

The chain cleaning device can also have a tray like extension 7 that is positioned below the chain 5 and situated between the front sprocket 3 and the chain cleaning device 6 with the scope of collecting the solution and dirt that drip from the chain 5 and direct them toward the housing 6.

The housing 6 can have an interlocking mechanism to host the tray 7. Different designs and shapes can provide this as skilled persons will readily recognize.

The housing 6 and tray 7 can be made in any solvent resistant material and have any color.

The housing 6 can partially cover the rear sprocket 4 and the chain 5, and different shapes can provide the same functionality of creating a bath-like enclosure for the chain cleaning solution.

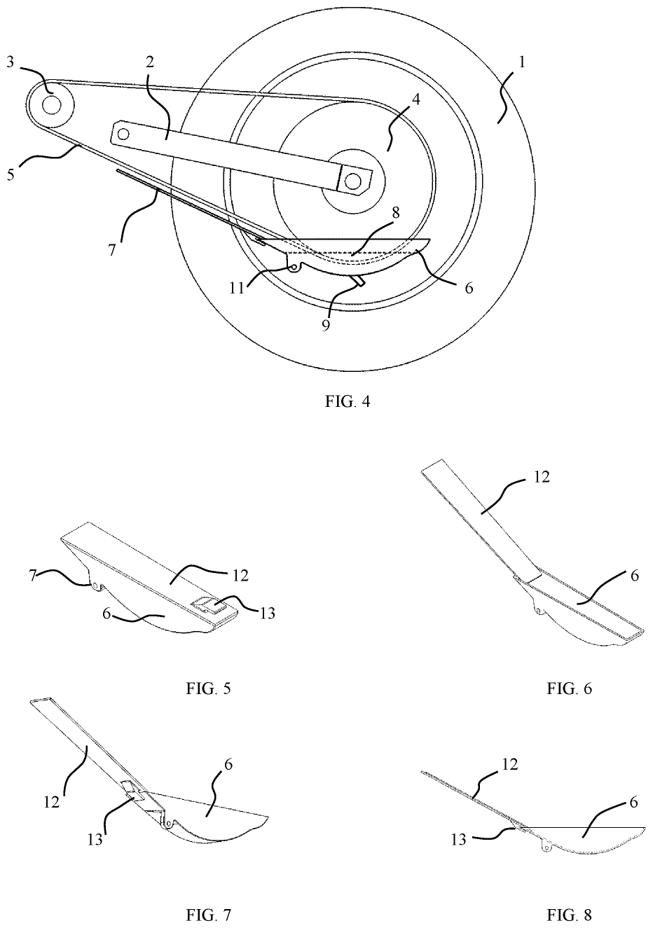

The housing 6 can have a round shape to emulate the rear sprocket 4 and then extends toward the front of the vehicle to follow the chain 5 shape like shown in FIGS. 1 and 4.

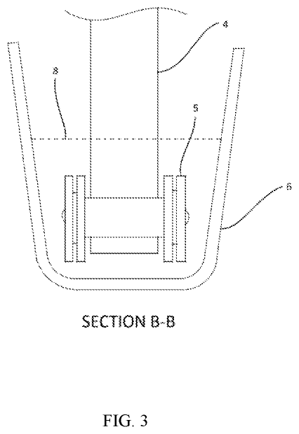

The side walls and the bottom of the housing 6 create a bath-like enclosure like shown in FIG. 3, where the cleaning solution 8 can be added.

The cleaning solution 8 can cover the chain 5 completely or partially to clean it.

The position of the housing of the chain cleaning device can be fixed in the specific position by different methods, attaching arms or clips, and could be generic or bike specific.

The chain 5 will be submerged in the solution 8 hosted in the housing 6. The cleaning solution will wash all the areas of the chain submerged in the solution. The chain 5 will be moved to pass through the cleaning solution 8 by rotating the wheel 1 or other method. As a new part of the chain 5 will be submerged in the cleaning solution 8, it will be cleaned.

The chain 5 movement through the cleaning solution 6 will agitate the solution and provide a better cleaning. The engaging of the chain 5 around the rear sprocket 4 will force a rotation of the links related to one another, helping with the cleaning process.

A brush 10 can be added to help with the removal of the dirt from the chain by direct physical contact as shown in FIG. 1.

As shown in FIG. 2, the tray 7 is positioned below the chain 5. The tray can have different shapes that can ensure that the solution and dirt dripping from the chain are collected and directed toward the housing 6.

FIG. 3 shows a section of the housing of the chain cleaner 6 with cleaning liquid 8, the rear sprocket 4 partially submerged and the chain 5 completely submerged. The cleaning solution 8 will penetrate all the areas of the chain 5 while submerged.

Another version of the design is shown in FIG. 4, having the same functionality to clean the chain 5 by allowing to be submerged in cleaning solution 8 on the housing 6.

A different shape of the housing 6 can create a surface that can be closed by a cover 12 to seal the inside of the housing when not in use. The cover 12 will copy the top surface of the housing 6 to eliminate leaks when paired together.

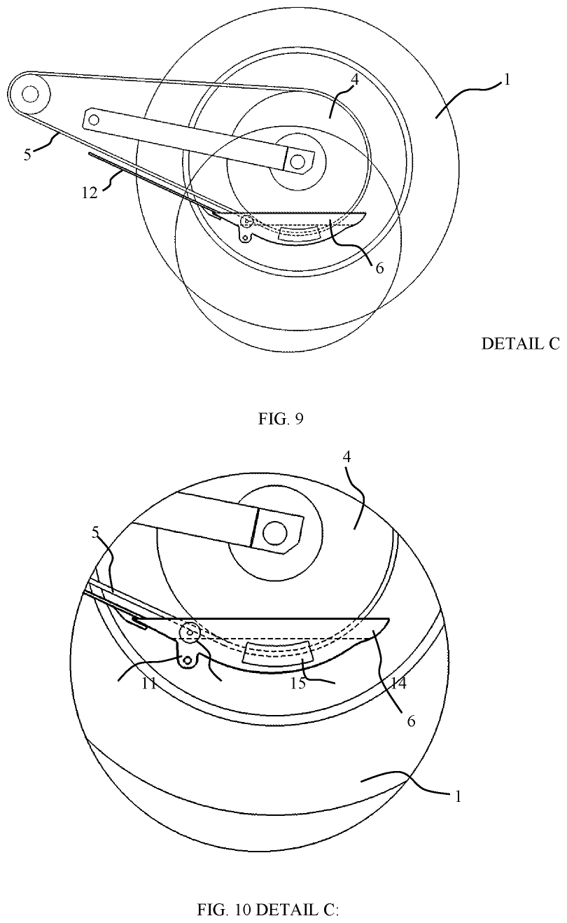

The cover 12 has a feature that will allow to be positioned as a tray when in use, to collect the drips from the chain 5, as shown in FIGS. 4, 5, 6, 7 and 8. Different designs could result in the same functionality as skilled persons will readily recognize. The cover 12 could also have another feature that could be fixing the cover 12 in close position over the housing 6 when not in use as shown in FIG. 5

In the design shown in FIGS. 4, 5, 6, 7, 8, 9 and 10, the mounting of the cleaning device is made possible by the mounting feature 11. An attaching arm can be attached to this feature to position and hold the cleaning device 6 in the right position to allow the chain 5 to be submerged in the solution 6 and be cleaned. Different type of vehicles or chain driven mechanisms would have a different type of attaching method, having all the same function of holding the cleaning device in the right position, as skilled persons will readily recognize.

The mounting feature 11 can have different designs, shapes and the housing of the cleaning device can be mounted on the vehicle with different methods.

The attaching arm could allow the housing 6 to be positioned in a lowered position after cleaning the chain 5. This position would allow the chain 5 to be outside of the cleaning solution 8 for a draining of the solution back to the housing 6 from the chain.

The housing 6 could have a draining tube 9 that allows for the draining of the cleaning solution 8 and the dirt accumulated, without lowering the position of the housing 6.

The housing 6 could be temporarily installed on the vehicle to allow the cleaning of the chain 5. The housing 6 could also be installed directly on the vehicle, or fixed on a stand that will give it the same position related to the chain 5 and allow the chain to be submerged in solution 8.

The housing could also have an individual support that is independent and would allow the housing 6 to be positioned in the same way as previous methods to clean the chain 5 without being connected to the vehicle or the supporting stand.

One or more fixed brushes 14 can be installed on the side walls and/or the bottom of the housing 6. These brushes can have different shapes to interact with the chain 5 and allow for a scraping of the areas of the chain for a better cleaning. These brushes 14 can be mounted in different positions to optimize the cleaning of the chain 5 as shown in FIGS. 9 and 10.

Rotating brushes 15 can also be installed on the housing 6. This rotating brushes 15 would interlock with the chain 5 and would be engaged in a rotational movement by the moving chain 5 to increase the cleaning action as shown in FIGS. 9 and 10.

The invention and its attendant advantages will be understood from the foregoing description and it will be apparent that various changes may be made in the form construction, design and arrangements of the parts without departing from the spirit and scope thereof or sacrificing its material advantages, the arrangements herein before described being merely by way of example. I do not wish to be restricted to the specific forms shown or uses mentioned, except as defined in the accompanying claims, wherein various portions have been separated for clarity of reading and not for emphasis.

1. A chain cleaning device for cleaning a chain while the chain is functionably mounted on a chain driven mechanism, the chain being moveable through the cleaning device comprising:
a housing having side walls and a bottom creating a cavity for receiving a cleaning solution; and
housing attachment for mounting the housing to partially cover a sprocket of the chain driven mechanism, wherein the housing attachment is configured to force contact between at least a portion of the chain and the cleaning solution when the cavity is filled therewith,
wherein the chain cleaning device is configured to clean the chain when the chain progresses through the chain driven mechanism.

2. The chain cleaning device of claim 1, further comprising a removable cover adapted to fit the housing.

3. The chain cleaning device of claim 2, wherein the removable cover is further adapted to cap the housing when un-mounted from the chain driven mechanism.

4. The chain cleaning device of claim 2, wherein the removable cover is further adapted to attach sideways to the housing, when the housing is mounted in working position, for collecting drips from the chain.

5. The chain cleaning device of claim 1, wherein the housing comprises a draining hole for removing the cleaning solution therefrom.

6. The chain cleaning device of claim 1, wherein the housing comprises one or more brushes within the cavity in contact with the chain.

7. The chain cleaning device of claim 6, wherein the one or more brushes are replaceably attached to the housing.

8. The chain cleaning device of claim 6, wherein the one or more brushes are frictionally rotating on the chain when the chain progresses in the housing.

9. A method of cleaning a chain of a chain driven mechanism while the chain remains on the vehicle, said method comprising:
having the chain exposed in the chain driven mechanism, mounting a chain cleaning device in a lowest position of the chain driven mechanism;
adding a chain cleaning solution in the chain cleaning device until partially or completely submerging the chain therein;
causing the chain to progress in the chain driven mechanism, wherein the chain is forced through the chain cleaning device;
lowering the device to allow the cleaning solution to drain and be collected in the chain cleaning device
